(19) United States
(12) Patent Application Publication
(10) Pub. No.: US 2002/0095329 A1
(43) Pub. Date: Jul. 18, 2002

(54) Product selector

(76) Inventors: Josh Malik, Racine, WI (US); Scott Mark Niesen, East Troy, WI (US)

Correspondence Address: Robert McAughan, Howrey Simon Arnold & White, LLP, 750 Bering Drive, Houston, TX, 77057-2198, US

(21) Appl. No.: 10/035,926

(22) Filed: Dec. 26, 2001

Related U.S. Application Data
(60) Provisional application No. 60/262,757, filed on Jan. 18, 2001.

(51) Int. Cl. G06F 17/60

(52) U.S. Cl. 705/10

(57) ABSTRACT

The invention includes a selector for recommending a product such as a food waste disposer based on at least a first and second question although additional questions could be used. The selector includes a base, a first moveable member, and a second moveable member. The base identifies the first question and the second question. The base may also have a first marker associated with the first question. The first moveable member is capable of moving relative to the base and the first marker. The first moveable member has a first response portion and a second marker. The first response portion is associated with the first question and the second marker is associated with the second question. The second moveable member is capable of moving relative to the base and the second marker. The second moveable member has a second response portion and a product selection marker. The second response portion is associated with the second question. The product selection marker is capable of indicating a recommended product when the first response portion is aligned with the first marker and the second response portion is aligned with the second marker. The first and second moveable members may move in the horizontal plane or rotate radially. The invention also includes methods of selecting a product.

### CROSS-REFERENCE TO RELATED APPLICATIONS

This application claims the benefit of the Provisional Application Serial No. 60/262,757, filed Jan. 18, 2001.

### BACKGROUND OF THE INVENTION

1. Field of the Invention

The present invention relates generally to a product selector and, more particularly to a product selector for a food waste disposer.

2. Relation to Prior Art

When selecting a product, such as a food waste disposer, consumers typically rely on a salesperson to provide them with the salient features of available products. Consumers may also seek information through merchandising signs, literature, or carton packaging. Salespersons may often be difficult to find or may provide unreliable or inconsistent information. Merchandising signs, literature and packaging may be helpful but are not interactive for the consumer. Furthermore, consumers may find the product specifications difficult to understand.

Based on these sources of information, the consumer proceeds to select their waste disposer. Unfortunately, consumers frequently select the product by relying merely on the price of the products, because the benefits derived from the different features are not always clear. A product selector is a device that provides the consumer with additional information when selecting a product.

For food waste disposers, it has been known to provide a product selector over the Internet. A consumer may respond to a series of questions. The responses to the questions are numerically weighted and added together. The sum of the numerically weighted answers is compared to ranges of numbers that correspond to a recommended type of food waste disposer. A need exists, however, to provide a product selector inside the store for consumers that do not have access to the Internet. There is also a need to provide a product selector that does not require a power supply.

The present invention is directed to overcoming, or at least reducing the effects of, one or more of the problems set forth above.

### SUMMARY OF THE INVENTION

To that end, the present invention includes a selector for recommending a product such as a food waste disposer based on at least a first and second question. The selector includes a base, a first moveable member, and a second moveable member. The base identifies the first question and the second question. The base may also have a first marker associated with the first question. The first moveable member is capable of moving relative to the base and the first marker. The first moveable member has a first response portion and a second marker. The first response portion is associated with the first question and the second marker is associated with the second question. The second moveable member is capable of moving relative to the base and the second marker. The second moveable member has a second response portion and a product selection marker. The second response portion is associated with the second question. The product selection marker is capable of indicating a recommended product when the first response portion is aligned with the first marker and the second response portion is aligned with the second marker. The first and second moveable members may move in the horizontal plane or rotate radially.

In another embodiment, the present invention includes a selector for recommending a product such as a food waste disposer based on at least a first, second and third question. The selector includes a base, a first moveable member, a second moveable member and a third moveable member. The base identifies the first, second and third questions. The base may also have a first marker associated with the first question. The first moveable member is capable of moving relative to the base and the first marker. The first moveable member has a first response portion and a second marker. The first response portion is associated with the first question and the second marker is associated with the second question. The second moveable member is capable of moving relative to the base and the second marker. The second moveable member has a second response portion and a third marker. The second response portion is associated with the second question and the third marker is associated with the third question. The third moveable member is capable of relative to the base and the third marker. The third moveable member has a third response portion and a product selection marker. The third response portion is associated with the third question. The product selection marker is capable of indicating a recommended product when the first response portion is aligned with the first marker, the second response portion is aligned with the second marker, and the third response portion is aligned with the third marker.

In further embodiment, the present invention includes a selector for recommending a product such as a food waste disposer based on at least a first, second, third and fourth question. The selector includes a base, a first moveable member, a second moveable member, a third moveable member and a fourth moveable member. The base identifies the first, second, third and fourth questions. The base may also have a first marker associated with the first question. The first moveable member is capable of moving relative to the base and the first marker. The first moveable member has a first response portion and a second marker. The first response portion is associated with the first question and the second marker is associated with the second question. The second moveable member is capable of moving relative to the base and the second marker. The second moveable member has a second response portion and a third marker. The second response portion is associated with the second question and the third marker is associated with the third question. The third moveable member is capable of relative to the base and the third marker. The third moveable member has a third response portion and a fourth marker. The third response portion is associated with the third question and the fourth marker is associated with the fourth question. The fourth moveable member is capable of moving relative to the base and the fourth marker. The fourth moveable member has a fourth response portion and a product selection marker. The fourth response portion is associated with the fourth question. The product selection marker is capable of indicating a recommended product when the first response portion is aligned with the first marker, the second response portion is aligned with the second marker, the third response portion is aligned with the third marker, and the fourth response portion is aligned with the fourth marker.

Another embodiment of the present invention includes a method for selecting a product. The method includes: sliding a moveable member in response to a first question; aligning one of a plurality of first responses on a first moveable member to a first marker; sliding a second moveable member in response to a second question; aligning one of a plurality of second responses on a second moveable member to a second marker; sliding a third moveable member in response to a third question; aligning one of a plurality of third responses on a third moveable member to a third marker; sliding a fourth moveable member in response to a fourth question; aligning one of a plurality of fourth responses on a fourth moveable member to a fourth marker; wherein a product selection marker on the fourth moveable member is capable of sliding to a recommended product.

A still further embodiment of the present invention includes a method for selecting a product. The method includes: rotating a moveable member in response to a first question; aligning one of a plurality of first responses on a first moveable member to a first marker; rotating a second moveable member in response to a second question; aligning one of a plurality of second responses on a second moveable member to a second marker; rotating a third moveable member in response to a third question; aligning one of a plurality of third responses on a third moveable member to a third marker; rotating a fourth moveable member in response to a fourth question; aligning one of a plurality of fourth responses on a fourth moveable member to a fourth marker; wherein a product selection marker on the fourth moveable member is capable of rotating to a recommended product.

In another embodiment, the present invention includes a method to facilitate a consumer in selecting a product. The method includes: providing a mechanical interface for the customer; offering a plurality of questions to the consumer on the mechanical interface; having the consumer respond to each question by mechanically selecting one of a plurality of responses; dimensionally weighting each response for each question; dimensionally summing the responses to the questions; and indicating the product selected by the dimensional sum of the responses.

### BRIEF DESCRIPTION OF THE DRAWINGS

The foregoing, a preferred embodiment and other aspects of the present invention will be best understood with reference to a detailed description of specific embodiments of the invention, which follows, when read in conjunction with the accompanying drawings, in which:

FIGS. 1-2 illustrate an embodiment of a product selector according to the present invention;

FIG. 3 illustrates a schematic embodiment of the present invention; and

FIG. 4 illustrates another embodiment of the product selector according to the present invention.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modification, equivalents, and alternatives falling within the scope of the invention as defined by the appended claims.

### DETAILED DESCRIPTION OF THE INVENTION

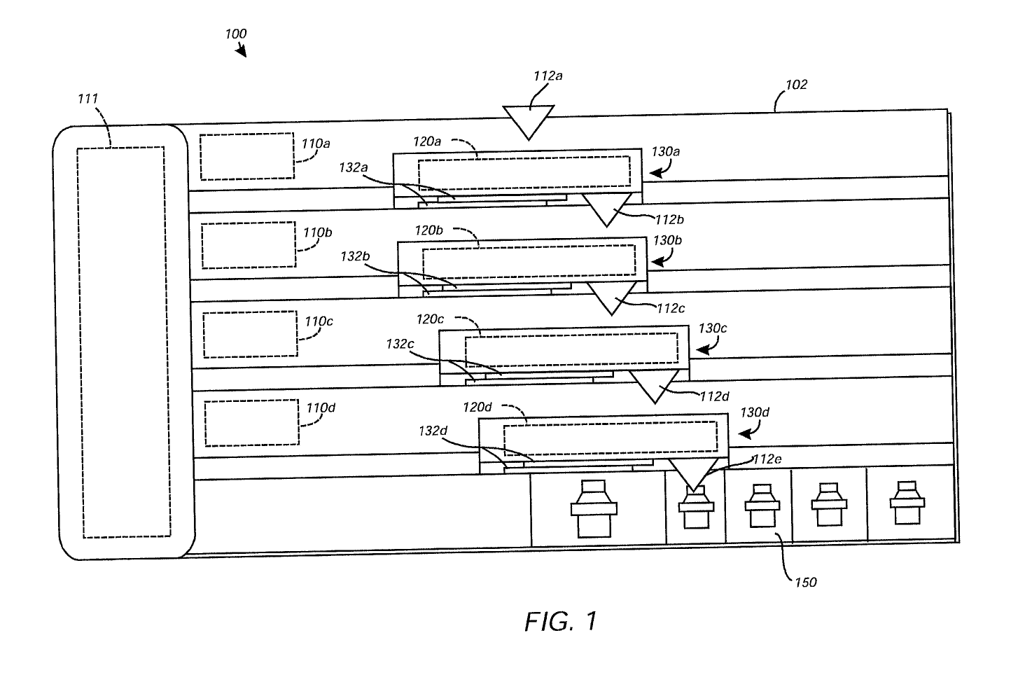

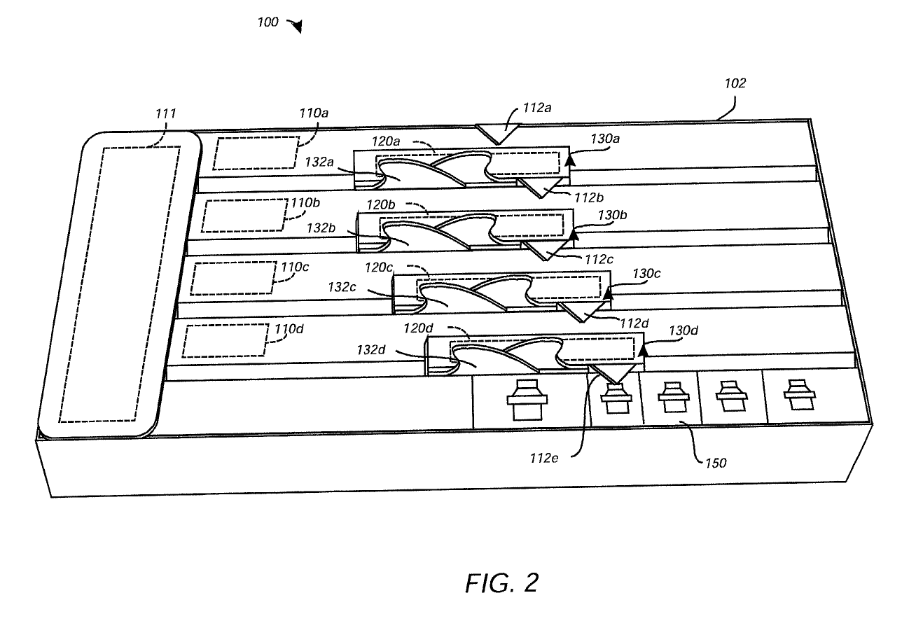

FIGS. 1-2 illustrate an embodiment of a product selector 100 according to the present invention. To eliminate confusion for the consumer when selecting a product, the product selector 100 asks the consumer everyday preferences and usage questions 110a-d. For example, the consumer may be seeking the best food waste disposer for their needs. In a preferred embodiment, the consumer is asked four questions 110a-d relating to everyday preferences and kitchen usage, such as: “How many people live in your household?” 110a; “How important is quiet operation to you?” 110b; “How many days per week are meals eaten at home?” 110c; and “How important is long product life to you?” 110d. The product selector 100 may also have a section 111 to provide instructions on the use of the machine and to identify other information from the manufacturer or seller.

The product selector 100 provides a mechanical interface that allows the consumer to make an informed decision without prior technical knowledge of food waste disposers or electric motors. The consumer can go back and easily change their answers and receive a new recommendation. Additionally, the product selector 100 requires no electricity and low maintenance. The product selector 100 has the further advantage of being easy to install and place into service.

The product selector 100 includes a base panel 102. The base panel 102 supports a plurality of interrelating moveable members 130a-d for movement thereon. In the present embodiment, the interrelating moveable members 130a-d define ruled slides that move relative to one another on the base panel 102. Each moveable member 130a-d has a response portion, a marker portion, and a movement handle or tab. For instance, in one embodiment having four moveable members 130a-130d, each moveable member 130a-130d slides relative to base panel 102 by squeezing the associated tab 132a-132d. The first moveable member 130a has a first response portion 120a that corresponds to a first question 110a and a second marker 112b that corresponds to a second question 110b. The second moveable member 130b has a second response portion 120b that corresponds to a second question and a third marker 112c that corresponds to a third question. The third moveable member 130c has a third response portion 120c that corresponds to a third question 110c and a fourth maker 112d that corresponds to a fourth question. The fourth moveable member 130d has a fourth response portion 120d that corresponds to a fourth question and a fifth marker 112e that corresponds to a recommended product. Each moveable member 130a-d has a movement handle or tab 132a-d for the consumer to move the moveable member 130a-d to select the best response 120a-d to the question 110a-d. In one embodiment, the moveable members 130a-d are mechanically interlocked. A consumer can move a moveable member 130a-d by squeezing the movement tab 132a-d to release and permit the moveable member 130a-d to slide horizontally.

In operation, the consumer reads the first question 110a. The first question 110a situates on a fixed portion of the product selector 100. To answer the first question 110a, the consumer selects the best response identified on the first response portion 120a by moving the first moveable member 130a. For example, the first question may ask, “How many people live in your household?” A plurality of responses is provided on the first response portion 120a of the moveable member 130a. The plurality of responses in the first response portion 120a may include a range of preferences, such as: “1-2,” “3-4”, “5-6”, and “7 or more.” To select the best response, the consumer squeezes the movement tab 132a and slides the first moveable member 130a so that the appropriate response in the first response portion 120a lines up with the first marker 112a. In one embodiment, the first marker 112a is fixed to the base panel 102.

In addition to the first response portion 120a, the first moveable member 130a has a second marker 112b that moves therewith. The second marker 112b is associated with the second question 110b.

The consumer reads the second question 110b and selects the best response identified on the second response portion 120b of the second moveable member 130b. The second question 110b may ask, “How important is quiet operation?” The plurality of responses provided on the second response portion 120b may include a range of preferences, such as: “not at all’, “not very,” “neutral,” “somewhat” and “very.” To select the best response, the consumer squeezes the movement tab 132b and slides the second moveable member 130b so that the appropriate response in the second response portion 120b lines up with the second marker 112b.

In addition to the second response portion 120b, the second moveable member 130b has a third marker 112c that moves therewith. The third marker 112c is associated with the third question 110b.

The consumer reads the third question 110c and selects the best response identified on the third response portion 120c of the third moveable member 130c. The third question 110c may ask, “How many days per week are meals eaten at home?” The plurality of responses provided on the second response portion 130c may include a range of choices, such as: “1”, “2”, “3”, “4 or 5” and “6 or 7”. To select the best response, the consumer squeezes the movement tab 132c and slides the third moveable member 130c so that the appropriate response in the third response portion 120c lines up with the third marker 112c.

Again, in addition to the third response portion 120c, the third moveable member 130c has a fourth marker 112d that moves therewith. The fourth marker 112d is associated with the fourth question 110b.

The consumer reads the fourth question 110d and selects the best response identified on the fourth response portion 120d of the fourth moveable member 130d. The fourth question 110d may ask, “How important is long product life?” The plurality of responses 120d provided on a fourth ruled slide 130d may include a range of choices, such as “not at all’, “not very”, “neutral,” “somewhat” and “very”. To select the best response 120d, the consumer squeezes the movement tab 132d and slides the fourth moveable member 130d so that the appropriate response in the fourth response portion 120d lines up with the fourth marker 112d.

The fourth moveable member 130d has a product selection marker 112e that moves therewith. A plurality of product selection choices 150 situate on the base panel 102 and remain fixed in relation to the moveable members 130a-d. By answering all of the questions 110a-d with the moveable members 130a-d, the product selection marker 112e points to a recommended product model.

To help the consumer associate each question 110a-d with its appropriate responses, each component associated with a question may have separate colors. For example, the first question 110a, the first marker 112a, and the first response portion 120a of the first moveable member 130a may all be one color. Similarly, the second question 110b, the second marker of the first moveable member 130a, and the second response portion 120b of the second moveable member 130b may be another color. The components associated with the third and fourth questions would also have different colors. It is further understood that instructions and other visuals may be offered on the product selector to allow the consumer to property operate the present invention.

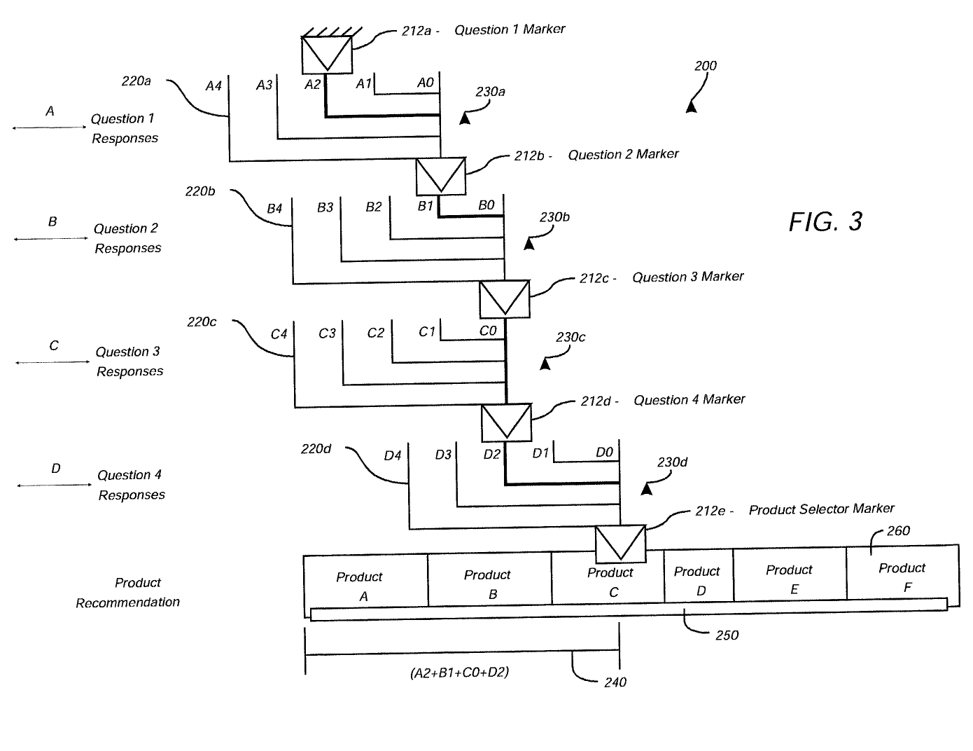

FIG. 3 illustrates a schematic embodiment of the present invention. The schematic embodiment illustrates how the questions and responses work as a system 200 to indicate a recommended model according to the present invention. The system 200 uses a multi-variant analysis giving specific weights to a range of answers. In one embodiment, the system 200 has a plurality of moveable members 230a-230d. Each moveable member 230a-230d has a response portion 220a-d and a marker portion 212b-212e. The consumer answers each question by moving each moveable member 230a-230d. The responses identified in the response portion 220a-d are measured and drawn to specific scales. Each response has a dimensional distance. For example, the first question has five responses having the dimensional distances of a0, a1, a2, a3, and a4. These distances need not be equally proportioned with respect to one another, but may have individual weighting. The exact weighting is implementation specific based on the product model and the type of relevant questions and responses for the model.

The consumer slides the moveable members 230a-d so that the response in the response portion 220a-d matches the corresponding marker 212a-212d. Moving moveable member 230a-d creates a dimensional distance. For example, a consumer answers the first question by moving the first moveable marker 230a in direction A and aligning the first marker 212a with a response. This movement causes a first dimensional distance, i.e., a0, a1, a2, a3, or a4, to be attained. For example, FIG. 3 shows a response to the first question resulting in a dimensional distance of a2. In one embodiment, each moveable member 230a-d is interlinked with other moveable members 230a-d. Thus, moving the first moveable member 230a will move the other moveable members 230b-230d.

The consumer then answers the second question by moving the second moveable member 230b in direction B and aligning the second marker 212b with a response. This movement causes a second dimensional distance, i.e., b0, b1, b2, b3, or b4, to be attained. For embodiments with interlinking members, the movement of the second moveable member 230b moves the third moveable member 230c and the fourth moveable member 230d.

The consumer answers the third question by moving the third moveable member 230c in direction C and aligning the third maker 212c with a response. This movement causes a third dimensional distance, i.e., c0, c1, c2, c3, or c4, to be attained. FIG. 3 shows a response to the third question resulting in a dimensional distance of c0. For embodiments with interlinking members, the movement of the third moveable member 230c moves the fourth moveable member 230d.

The consumer answers the fourth question by moving the fourth moveable member 230d in direction D and aligning the fourth marker 212d with a response. This movement causes a fourth dimensional distance, i.e., d0, d1, d2, d3, or d4, to be attained. FIG. 3 shows a response to the fourth question having a dimensional distance of d2. The fourth moveable member 230d has a product selection marker 212c that points to a recommended product model. A geometrical solution 240 is achieved by moving the moveable members 230a-d. The geometrical solution 240 for the product selection marker 112d lies along a value line 250. The location of the geometrical solution 240 along the value line 250 may be reached in a number of ways including the summing of the individual responses 220a-c. For example, as shown in FIG. 3, when responses corresponding to dimensional distances a2, b1, c0 and d2 are chosen, the product selection marker 212e slides over a distance having the sum of a2+b1 +c0+d2.

Overlaying the value line 250 is a plurality of individual model recommendations 260. Each of the individual model recommendations 260 has a dimensional size relative to the value line 250. Although six model recommendations 260 are shown in FIG. 3, the present invention may use more or fewer models. Furthermore, the dimensional sizes for the model recommendations 260 need not be the same for each model, but may differ to provide further weighting to the individual model recommendations 260. The geometrical solution 240, resulting from the sum of the responses 220a-c, lies on the value line 250 within one of the individual model recommendations 260. The location of the geometrical solution 240 indicates a specific model that meets the consumer's needs.

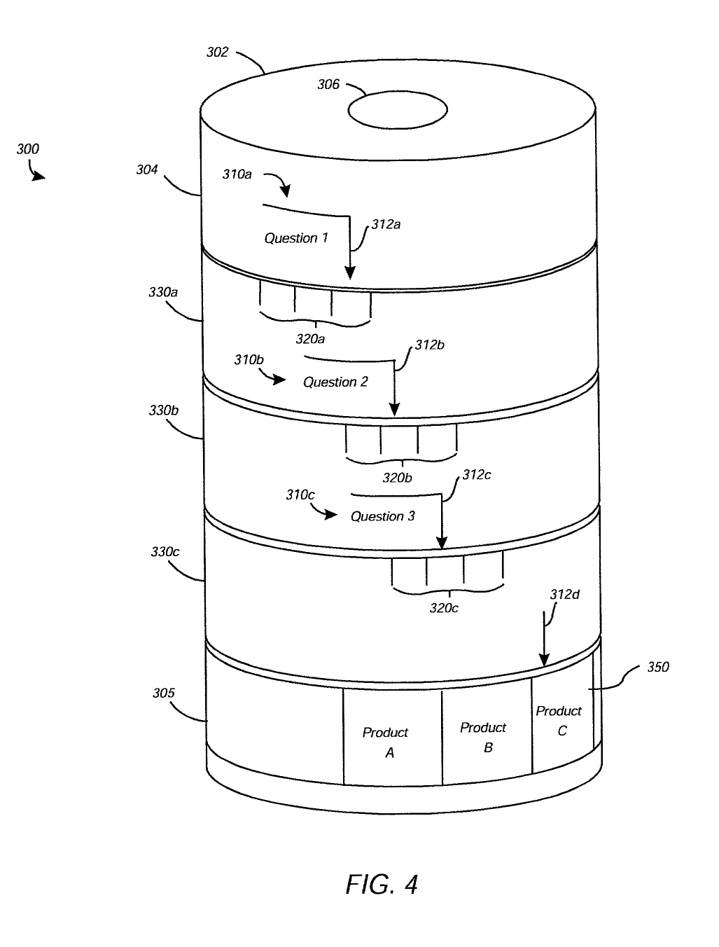

FIG. 4 illustrates another embodiment of a product selector 300 according to the present invention. The product selector 300 includes a cylindrical structure 302. A top disc 304 remains fixed to a shaft 306. The shaft 306 runs axially through the cylindrical structure 302 to a base. A plurality of interrelating moveable members 330a-c situate on the shaft 306 for rotation thereon. In the present embodiment, the interrelating portions 330a-c define ruled discs and rotate relative to each other. The consumer selects the best model for his or her needs by rotating each moveable member 330a-c to respond to each question 310a-c. Each moveable member has a response portion 320a-c and a marker 312b-312d. In this embodiment, the product is selected by answering three questions 310a-310c. However, one of ordinary skill in the art, with the benefit of the present specification, would realize that the product selector 300 could be modified to answer other numbers of questions.

The consumer reads the first question 310a that situates on the top fixed disc 304 of the product selector 300. A plurality of responses 320a is identified on the first moveable member 330a. The consumer then selects the best response or preference. To select the best response 320a, the consumer rotates the first moveable member 330a until the preferred response in the first response portion 320a aligns with the first marker 312a.

The first moveable member 330a has a second question 310b that rotates therewith. A plurality of responses 320b is provided on a second moveable member 330b. The consumer reads the second question 310b and selects the best response or preference. To select the best response 320b, the consumer rotates the second moveable member 330b until the preferred response in the second response portion 320b aligns with the second marker 312b.

Similarly, the second moveable member 330b has a third question 310c that rotates therewith. A plurality of responses 320c is provided on a third moveable member 330c. The consumer reads the third question 310c and selects the best response or preference. To select the best response 320c, the consumer rotates the third moveable member 330c until the preferred response in the third response portion 320c aligns with the third marker 312c.

The third moveable member 330c has a product selection marker 312e. A plurality of product selection choices 350 situates on a bottom fixed disc 305. The bottom disc 305 may be fixed relative to the shaft 306 and the top fixed disc 304. The moveable members 330a-c rotate relative to the fixed discs 304 and 305. As the moveable members 330a-c are rotated, the product selection marker 312e becomes reoriented in relation to the product selection choices 350. The best model for the consumer based on the responses 320a-c to the question 310a-c is then shown.

In this embodiment of the product selector 300, a similar approach may be used as shown and described in FIG. 3. Instead of dimensional distances that translate horizontally, the selector 300 in FIG. 4 can operate with dimensional distances that translate radially.

While the invention has been described with reference to the preferred embodiments, obvious modifications and alterations are possible by those skilled in the related art. Therefore, it is intended that the invention include all such modifications and alterations to the full extent that they come within the scope of the following claims or the equivalents thereof.

What is claimed is:

1. A selector for recommending a product based on at least a first question and a second question, the selector comprising:
a base identifying the first question and the second question;
a first marker associated with the first question;
a first moveable member capable of moving relative to the base and the first marker, the first moveable member having a first response portion and a second marker, the first response portion associated with the first question and the second marker associated with the second question; and
a second moveable member capable of moving relative to the base and the second marker, the second moveable member having a second response portion and a product selection marker, the second response portion associated with the second question;
wherein the product selection marker is capable of indicating a recommended product when the first response portion is aligned with the first marker and the second response portion is aligned with the second marker.

2. The selector of claim 1, wherein the first moveable member and the second moveable member are capable of moving in a horizontal plane.

3. The selector of claim 1, wherein the first moveable member and the second moveable member are capable of moving radially with respect to the base and the first marker.

4. The selector of claim 1, wherein the recommended product is a type of food waste disposer.

5. A selector for recommending a product based on at least a first question, a second question, and a third question, the selector comprising:
a base identifying the first question, the second question and the third question;
a first marker associated with the first question;
a first moveable member capable of moving relative to the base and the first marker, the first moveable member having a first response portion and a second marker, the first response portion associated with the first question and the second marker associated with the second question;
a second moveable member capable of moving relative to the base and the second marker, the second moveable member having a second response portion and a third marker, the second response portion associated with the second question and the third marker associated with the third question; and
a third moveable member capable of moving relative to the base and the third marker, the third moveable member having a third response portion and a product selection marker, the third response portion associated with the third question;
wherein the product selection marker is capable of indicating a recommended product when the first response portion is aligned with the first marker, the second response portion is aligned with the second marker, and the third response portion is aligned with the third marker.

6. The selector of claim 5, wherein the first moveable member, the second moveable member and the third moveable member are capable of moving in a horizontal plane.

7. The selector of claim 5, wherein the first moveable member, the second moveable member and the third moveable member are capable of moving radially with respect to the base and the first marker.

8. The selector of claim 5, wherein the recommended product is a type of food waste disposer.

9. A selector for recommending a product based on at least a first question, a second question, a third question, and a fourth question, the selector comprising:
a base identifying the first question, the second question, the third question and the fourth question;
a first marker associated with the first question;
a first moveable member capable of moving relative to the base and the first marker, the first moveable member having a first response portion and a second marker, the first response portion associated with the first question and the second marker associated with the second question;
a second moveable member capable of moving relative to the base and the second marker, the second moveable member having a second response portion and a third marker, the second response portion associated with the second question and the third marker associated with the third question;
a third moveable member capable of moving relative to the base and the third marker, the third moveable member having a third response portion and a fourth marker, the third response portion associated with the third question and the fourth marker associated with the fourth question; and
a fourth moveable member capable of moving relative to the base and the fourth marker, the fourth moveable member having a fourth response portion and a product selection marker, the fourth response portion associated with the fourth question;
wherein the product selection marker is capable of indicating a recommended product when the first response portion is aligned with the first marker, the second response portion is aligned with the second marker, the third response portion is aligned with the third marker, and the fourth response portion is aligned with the fourth marker.

10. The selector of claim 9, wherein the first moveable member, the second moveable member and the third moveable member are capable of moving in a horizontal plane.

11. The selector of claim 10, wherein the first moveable member, the second moveable member and the third moveable member are capable of moving radially with respect to the base and the first marker.

12. The selector of claim 10, wherein the recommended product is a type of food waste disposer.

13. A method for selecting a product, comprising:
sliding a first moveable member in response to a first question;
aligning one of a plurality of first responses on the first moveable member to a first marker;
sliding a second moveable member in response to a second question;
aligning one of a plurality of second responses on the second moveable member to a second marker, the second marker located on the first moveable member;
sliding a third moveable member in response to a third question;
aligning one of a plurality of third responses on the third moveable member to a third marker, the third marker located on the second moveable member;
sliding a fourth moveable member in response to a fourth question; and
aligning one of a plurality of fourth responses on the fourth moveable member to a fourth marker, the fourth marker located on the third moveable member;
wherein a product selection marker on the fourth moveable member is capable of sliding to a recommended product.

14. The selector of claim 13, wherein the product is a food waste disposer.

15. A method for selecting a product by a consumer, comprising:
rotating a first moveable member in response to a first question;
aligning one of a plurality of first responses on the first moveable member to a first marker;
rotating a second moveable member in response to a second question;
aligning one of a plurality of second responses on the second moveable member to a second marker, the second marker located on the first moveable member;
rotating a third moveable member in response to a third question;
aligning one of a plurality of third responses on the third moveable member to a third marker, the third marker located on the second moveable member;
rotating a fourth moveable member in response to a fourth question; and
aligning one of a plurality of fourth responses on the fourth moveable member to a fourth marker, the fourth marker located on the third moveable member;
wherein a product selection marker on the fourth moveable member is capable of rotating to a recommended product.

16. The selector of claim 15, wherein the product is a food waste disposer.

17. A method to facilitate a consumer in selecting a product, comprising:
providing a mechanical interface for the consumer;
offering a plurality of questions to the consumer on the mechanical interface; having the consumer respond to each question by mechanically selecting one of a plurality of responses;
dimensionally weighting each response for each question;
dimensionally summing the responses to the questions; and
indicating the product selected by the dimensional sum of the responses.

18. The selector of claim 17, wherein the product is a food waste disposer.
